(19) United States
(12) Patent Application Publication
(10) Pub. No.: US 2009/0063212 A1
(43) Pub. Date: Mar. 5, 2009

(54) BUSINESS TRANSFORMATION

(75) Inventor: Pamela K. Isom, Highlands Ranch, CO (US)

Correspondence Address: IBM CORPORATION, IPLAW SHCB/40-3, 1701 NORTH STREET, ENDICOTT, NY, 13760, US

(73) Assignee: INTERNATIONAL BUSINESS MACHINES CORPORATION, Armonk, NY (US)

(21) Appl. No.: 11/847,429

(22) Filed: Aug. 30, 2007

(51) Int. Cl. G06F 9/44

(52) U.S. Cl. 705/7

(57) ABSTRACT

Business processes are transformed into a solution having a portal for a service-oriented architecture. A plan for the transformation is created, including a portal implementation roadmap. A services providing company deploys the solution to a client company.

This application is related to the application titled, “Transformational Method” filed on the same date by the same inventor.

### TECHNICAL FIELD

The invention relates to methods of transforming business operations. More particularly, the business operations are transformed to a portal having service oriented architecture solutions.

### BACKGROUND OF THE INVENTION

Business services providing companies have achieved considerable success in quickly transforming traditional processes using service-oriented architecture (SOA) techniques. Such transformations are then deployed to the client company by a services providing company.

For example, Crawford, et al., in their article, “Toward an on Demand Service-oriented Architecture”, IBM Systems Journal, volume 44, no. 1, 2005, pages 81-107, describe an extension of SOA called on demand SOA. On demand SOA includes comprehensive integration of business process transformation with service-oriented development and policy-based information technology (IT) management.

Cherbakov, et al, in their paper, “Impact of Service Orientation at the Business Level”, IBM Systems Journal, volume 44, no. 5, 2005, pages 653-668, describe the changes needed to transform a company into an on demand business. They describe componentization and the need for service orientation to integrate these components.

Ferguson and Stockton in their paper, “Service-oriented Architecture: Programming Model and Product Architecture”, IBM Systems Journal, volume 44, no. 4, 2005, pages 753-780, describe the IBM SOA programming model.

Rackham in U.S. Patent application 2005/0203784 describes a method of operating a business according to a component business modeling approach.

U.S. patent application Ser. No. 11/496,917 filed Jul. 13, 2006, describes further methods for implementing service-oriented architecture solutions to business models created through component business modeling or other techniques.

The papers listed above by Crawford, Cherbakov, and Ferguson, as well as the Rackham patent application and patent application Ser. No. 11/496,917, shall be incorporated herein by reference in their entireties.

In spite of the developments just described, there remains considerable opportunity for further developments and improvements in the methods of transforming businesses. In particular, the use of portal transformations with service-oriented architecture solutions has been found to have numerous advantages as will be described below. It is thought that such solutions would constitute a significant advancement in the art.

### OBJECTS AND SUMMARY OF THE INVENTION

It is therefore a principal object of the present invention to enhance the business transformation art by providing transformation methods and services with enhanced capabilities.

It is another object to provide methods of planning such a transformation.

It is yet another object to provide business transformation methods which can be implemented in a facile manner.

These and other objects are attained in accordance with one embodiment of the invention wherein there is provided a method of deploying a business operations transformation to a client of a portal with a service-oriented architecture solution, comprising the steps of; creating a portal vision and strategy, creating a security vision and strategy, defining security entry points for a portal implementation with a SOA solution, defining content management strategy, vision, and guidelines, defining and publishing criteria for sunsetting non-value add portfolio components, identifying and defining portal best practices and portlet design guidelines for a SOA implementation, identifying project initiatives underway, timelines, and release plans, creating and publishing a portfolio evaluation report with sunset and migration recommendations, refining the future state architecture, identifying pilot programs and proof-of-concepts, creating an implementation roadmap, and implementing the roadmap for the client.

In accordance with another embodiment of the invention there is provided a method of deploying a business operations transformation to a client, comprising the steps of; creating an architecture vision and strategy, defining SOA entry points, creating a portal vision and strategy, defining portal entry points, creating a security vision and strategy, defining security entry points for a portal implementation with a SOA solution, defining content management strategy, vision, and guidelines, creating a business model, identifying domains and prioritizing business functions, creating a system context of current and planned architectural state, defining and publishing criteria for sunsetting non-value add portfolio components, defining and publishing criteria for outsourcing portfolio components, defining and publishing criteria for maintaining portfolio components, identifying and defining portal best practices and portlet design guidelines for a SOA implementation, identifying security best practices and design guidelines for a portal to SOA implementation, identifying governance best practices for a portal and SOA implementation, conducting a portfolio evaluation, aligning the portfolio to the business model, identifying and documenting gaps, identifying and reviewing business constraints, capturing new and existing business processes, business services and updating the business model, identifying project initiatives underway, timelines, and release plans, reviewing existing governance best practices, identifying required skills, talent, roles, and publishing a governance best practice document, reviewing project specific budgetary constraints, identifying vendor-specific requirements, creating and publishing a portfolio evaluation report with sunset and migration recommendations, refining the future state architecture, identifying pilot programs and proof-of-concepts, creating an implementation roadmap, and implementing the roadmap for the client.

### BRIEF DESCRIPTION OF THE DRAWINGS

FIG. 1 is a flowchart of steps for practicing the present invention; and

FIGS. 2a-2c are together a flowchart of the steps for practicing the present invention including optional steps.

### BEST MODE FOR CARRYING OUT THE INVENTION

For a better understanding of the present invention, together with other and further objects, advantages, and capabilities thereof, reference is made to the following disclosure and the appended claims in connection with the above-described drawings.

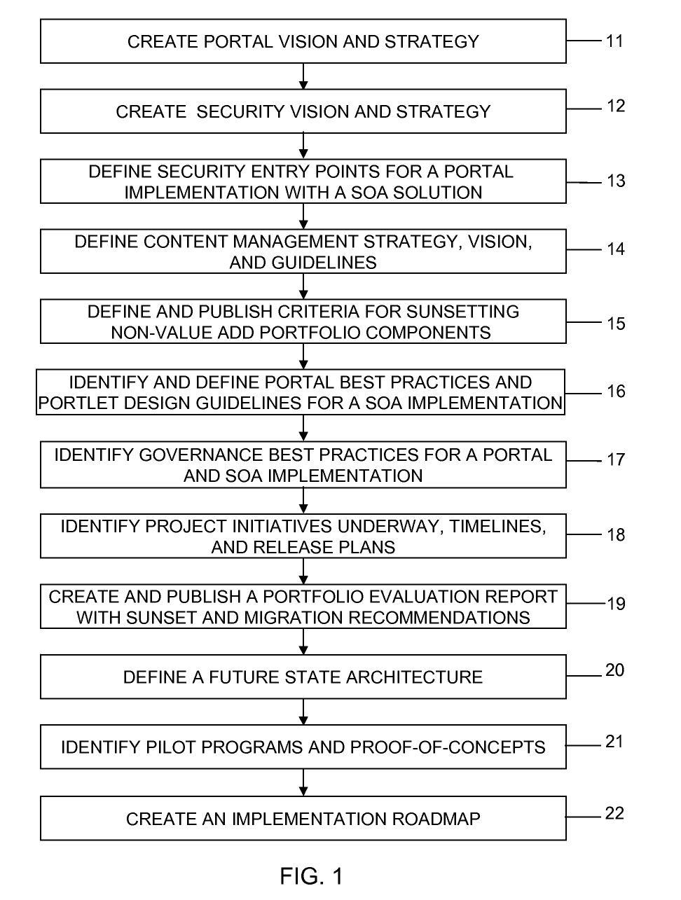

In FIG. 1, there is shown a flowchart of steps for practicing one embodiment of the present invention. In step 11, a portal vision and strategy are created. As used herein, portal shall be taken to mean a web system that provides the functions and features to authenticate and identify users and provide a user customizable web interface for access to information and services of interest to the users. The portal is a unique way of implanting a service-oriented architecture solution to the transformation of a company's business operations. The steps in FIG. 1 define a method of planning such an implementation.

In step 12, a security vision and strategy are created. The security vision and strategy includes authentication and authorization capability for portal access by users. In step 13, security entry points are defined for the portal implementation of the SOA solution.

In step 14, a content management strategy, vision, and guidelines are defined. Steps 11-14 comprise a grouping of steps for strategizing a vision of the transformation solution. Strategizing a vision is the first of three phases needing to be completed to plan for the transformation.

Steps 15-17 comprise a phase of synchronizing the vision by aligning current and planned objectives. In step 15, criteria for sunsetting non-value add portfolio components are defined and published. Published means the criteria are distributed to all affected parties. Components are technical solutions to a business requirement. Portfolio components are those components that are included in the current or planned solution inventory. Sunsetting means use of the application or component will be terminated. In step 16, portal best practices and portlet design guidelines are identified for the SOA implementation. A portal web page may have a plurality of different sets of portlets creating content for different users. By way of example, JSR (Java Specification Request) 168 defines a portlet as a Java-based web component, managed by a portlet container, that processes requests and generates dynamic content. Other specifications for portlets may also be used. Portals use portlets as pluggable user interface components that provide a presentation layer to information systems. In step 17, governance best practices are identified for the SOA implementation. As used herein, “governance” shall be taken to mean the establishment and enforcement of bylaws for designing and implementing a solution. In this case, the solutions are portal solutions in which SOA is the underlying interface pattern. Governance includes the identification of necessary human resources to ensure bylaws are defined, adapted, and executed including execution of exception processes. By way of example and not meant to be limiting, a governing best practice in large information technology departments is to have a portal center of competency in which there is a portal administrator, a portal architect, and an SOA integrator. These three individuals approve all portal related architectural designs before implementation may commence.

Steps 18-22 of FIG. 1 comprise the phase of realizing a roadmap which is the implementation plan for the portal SOA solution. In step 18, project initiatives already underway, timelines, and release plans are identified. In step 19, a portfolio evaluation report is created and published. The report shall include sunset and migration recommendations. Migration means it will be moved to a service outside of the SOA solution which is being planned.

In step 20, a future state architecture is defined. In step 21, pilot programs and proof-of-concept applications are identified. In step 22, an implementation roadmap is created.

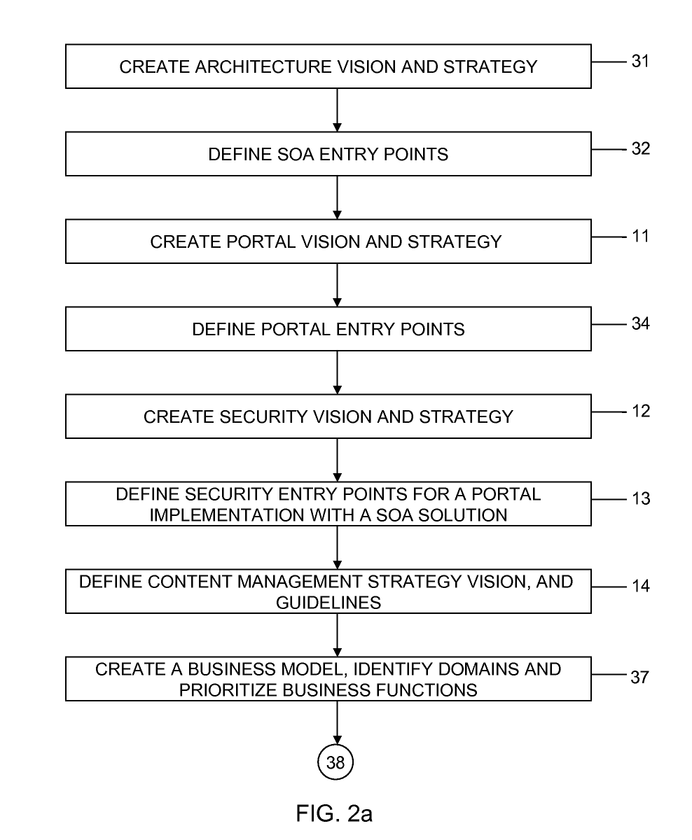

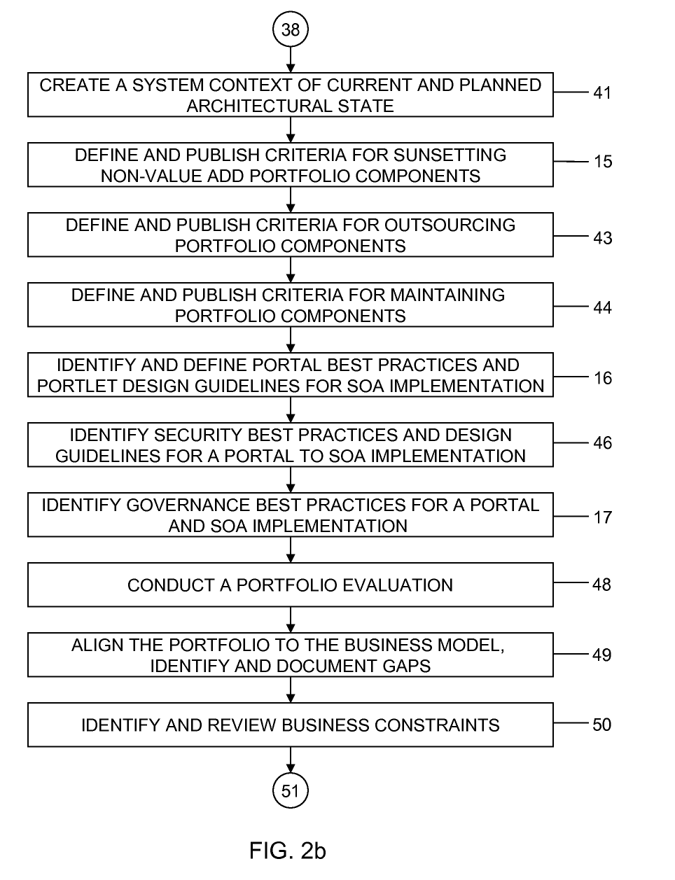

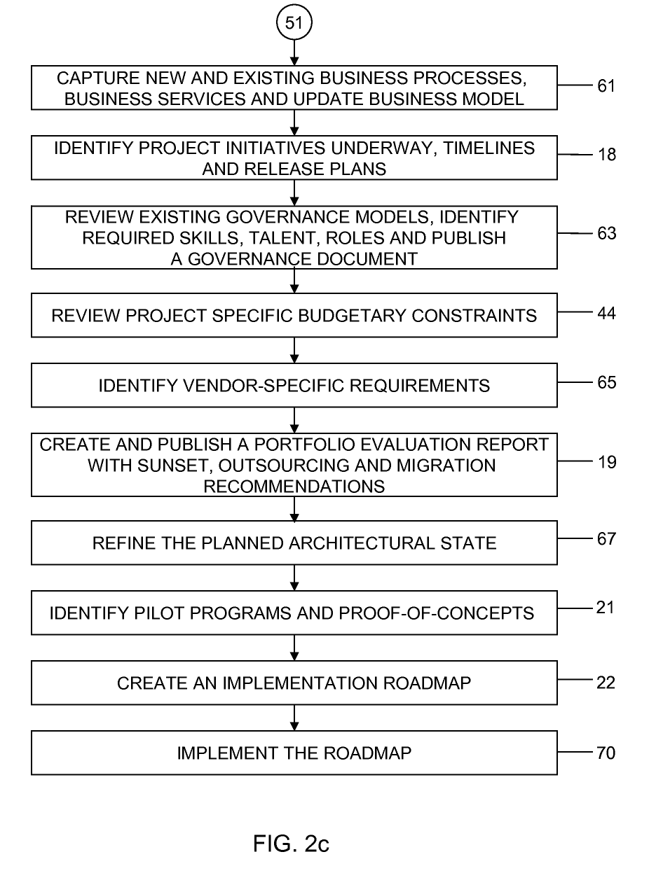

FIG. 2 illustrates another embodiment of the present invention having numerous steps which may be optional in specific embodiments. FIG. 2 is arranged so that strategize steps are shown in FIG. 2a, synchronization steps in FIG. 2b, and realizing steps in FIG. 2c. Steps which are identical to those just described for FIG. 1 are labeled with the same numbers.

In step 31, an architecture vision and strategy are created. The architecture includes an SOA approach to the business transformation using known SOA techniques, such as those described in the documents listed above. In step 32, SOA entry points are defined. In step 34, portal entry points are defined.

In step 37, a business model is created, domains identified, and business functions prioritized.

Regarding the synchronizing phase shown in FIG. 2b, in step 41, a system context of the current and planned architectural state is created. The planned architectural state is taken from the vision and strategy created in step 31. In step 43, criteria for outsourcing portfolio components is defined and published. Any component of the SOA solution may be selected for outsourcing depending on the criteria defined in step 43.

In step 44, criteria for maintaining portfolio components is defined and published. In step 46, best security practices and guidelines for a portal SOA implementation are identified. In step 48, a portfolio evaluation is conducted. For each component in the current portfolio, a determination is made whether to include that component in the planned portal solution. If so, any changes needed are determined. If not, then a decision is made whether to sunset the component, or whether certain parts of that component should be kept in the portal solution. In step 49, the portfolio is aligned to the business model created in step 37. Gaps are identified and documented.

In step 50, business constraints are identified and reviewed. By way of example and not limiting, are budgetary constraints, manpower constraints, and location constraints.

FIG. 2c illustrates steps in the realization phase of the business transformation. In step 61, the business model created in step 37 is updated after capturing new and existing business processes and business services. In step 63, required skills, talent, and roles are identified by reviewing the existing client governance best practices. A governance best practice document is published. In step 64, project specific budgetary constraints are reviewed. In step 65, vendor-specific requirements are identified. These requirements came about because an existing solution component may have been provided to the client by a vendor. That vendor may have placed a requirement, such as usage restrictions, on the client. In step 67, the architectural state from step 41 is refined based on information obtained in steps 15 to 19 of FIGS. 2b and 2c.

Finally, in step 70, the roadmap created in step 22 is implemented.

While there have been shown and described what are at present considered the preferred embodiments of the invention, it will be obvious to those skilled in the art that various changes and modifications may be made therein without departing from the scope of the invention as defined by the appended claims.

What is claimed is:

1. A method of deploying a business operations transformation to a client of a portal with a service-oriented architecture solution, comprising the steps of:
creating a portal vision and strategy;
creating a security vision and strategy;
defining security entry points for a portal implementation with a SOA solution;
defining content management strategy, vision, and guidelines;
defining and publishing criteria for sunsetting non-value add portfolio components;
identifying and defining portal best practices and portlet design guidelines for a SOA implementation;
identifying project initiatives underway, timelines, and release plans;
creating and publishing a portfolio evaluation report with sunset and migration recommendations;
refining the future state architecture;
identifying pilot programs and proof-of-concepts;
creating an implementation roadmap; and
implementing the roadmap for the client.

2. The method of claim 1, further comprising the step of defining portal entry points.

3. The method of claim 1, further comprising the step of creating a business model, identifying domains and prioritizing business functions.

4. The method of claim 1, further comprising the step of creating a system context of current and planned architectural state.

5. The method of claim 1, further comprising the step of defining and publishing criteria for outsourcing portfolio components.

6. The method of claim 1, further comprising the step of defining and publishing criteria for maintaining portfolio components.

7. The method of claim 1, further comprising the step of identifying security best practices and design guidelines for a portal to SOA implementation.

8. The method of claim 1, further comprising the step of identifying governance best practices for a portal and SOA implementation.

9. The method of claim 3, further comprising the step of aligning the portfolio to the business model, and identifying and documenting gaps.

10. The method of claim 1, further comprising the step of identifying and reviewing business constraints.

11. A method of deploying a business operations transformation to a client, comprising the steps of:
creating an architecture vision and strategy;
defining SOA entry points;
creating a portal vision and strategy;
defining portal entry points;
creating a security vision and strategy;
defining security entry points for a portal implementation with a SOA solution;
defining content management strategy, vision, and guidelines;
creating a business model, identifying domains and prioritizing business functions;
creating a system context of current and planned architectural state;
defining and publishing criteria for sunsetting non-value add portfolio components;
defining and publishing criteria for outsourcing portfolio components;
defining and publishing criteria for maintaining portfolio components;
identifying and defining portal best practices and portlet design guidelines for a SOA implementation;
identifying security best practices and design guidelines for a portal to SOA implementation;
identifying governance best practices for a portal and SOA implementation;
conducting a portfolio evaluation;
aligning the portfolio to the business model, identifying and documenting gaps;
identifying and reviewing business constraints;
capturing new and existing business processes, business services and updating the business model;
identifying project initiatives underway, timelines, and release plans;
reviewing existing governance best practices, identifying required skills, talent, roles, and publishing a governance best practices document;
reviewing project specific budgetary constraints;
identifying vendor-specific requirements;
creating and publishing a portfolio evaluation report with sunset and migration recommendations;
refining the future state architecture;
identifying pilot programs and proof-of-concepts;
creating an implementation roadmap; and
implementing the roadmap for the client.
